(19) United States
(12) Patent Application Publication
(10) Pub. No.: US 2026/0065878 A1
(43) Pub. Date: Mar. 5, 2026

(54) FRAME DISPLAY METHOD AND FRAME DISPLAY DEVICE

(71) Applicant: MEDIATEK INC., Hsinchu City (TW)

(72) Inventors: Yi-Hsin Shen, Hsinchu City (TW); Chi-Chiang Huang, Hsinchu City (TW); Nien-Hsien Lin, Hsinchu City (TW); Kuo-Yi Wang, Hsinchu City (TW); Chiu-Jen Lin, Hsinchu City (TW); Cheng-Che Chen, Hsinchu City (TW)

(73) Assignee: MEDIATEK INC., Hsinchu City (TW)

(21) Appl. No.: 19/308,295

(22) Filed: Aug. 24, 2025

Related U.S. Application Data
(60) Provisional application No. 63/688,424, filed on Aug. 29, 2024.

(51) Int. Cl. G09G 5/399

(52) U.S. Cl. CPC G09G 5/399; G09G 2330/02; G09G 2360/18

(57) ABSTRACT

A frame display method, applied to a frame display device installed with an application and comprising a plurality of buffers, comprising: (a) generating a first frame required by the application and storing the first frame to a first buffer; (b) generating a second frame required by the application after generating the first frame, and storing the second frame to a second buffer; (c) generating a target frame according to contents of the first frame and the second frame and discarding the first frame and the second frame from the first buffer and the second buffer, respectively, after the target frame is generated; and (d) displaying the target frame but not displaying the first frame and the second frame. A frame display device which can perform the frame display method is also disclosed.

### CROSS REFERENCE TO RELATED APPLICATIONS

This application claims the benefit of U.S. Provisional Application No. 63/688,424, filed on August 29, 2024. The content of the application is incorporated herein by reference.

### BACKGROUND

The present application relates to a frame display method and a frame display device, and particularly relates to a frame display method and a frame display device which can improve the buffer accumulation issue.

In a frame display device, such as a mobile phone or a computer, buffers are provided into a queue from which the frame display device retrieves them to update the display content. In other words, the frame display device sequentially retrieves frames from the buffers and then sequentially display the retrieved frames.

However, multiple buffers can accumulate in the queue, which is named as a phenomenon known as buffer accumulation. When the frame display device processes the buffered frames sequentially, the latest buffer waits for previous buffers to be handled. As a result, the display latency increases. Discarding older frames in buffers is a solution to overcome the latency issues. However, it can cause the display content to appear unsmooth. Increasing the frames per second (FPS) of the frame display device is also a possible solution, but it's limited by display hardware capabilities.

### SUMMARY

One objective of the present application is to provide a frame display method which can improve the buffer accumulation issue.

Another objective of the present application is to provide a frame display device which can improve the buffer accumulation issue.

One embodiment of the present application discloses: a frame display method, applied to a frame display device installed with an application and comprising a plurality of buffers, comprising: (a) generating a first frame required by the application and storing the first frame to a first buffer; (b) generating a second frame required by the application after generating the first frame, and storing the second frame to a second buffer; (c) generating a target frame according to contents of the first frame and the second frame and discarding the first frame and the second frame from the first buffer and the second buffer, respectively, after the target frame is generated; and (d) displaying the target frame but not displaying the first frame and the second frame.

Another embodiment of the present application discloses: a frame display device, installed with an application, comprising: a storage device, storing at least one program; a plurality of buffers, comprising a first buffer and a second buffer; and a processing circuit, configured to execute at least one program to perform a frame display method comprising: (a) generating a first frame required by the application and storing the first frame to a first buffer; (b) generating a second frame required by the application after generating the first frame, and storing the second frame to a second buffer; (c) generating a target frame according to contents of the first frame and the second frame and discarding the first frame and the second frame from the first buffer and the second buffer, respectively, after the target frame is generated; and (d) displaying the target frame but not displaying the first frame and the second frame.

In view of above-mentioned embodiments, the buffer accumulation issue can be improved, since more than one buffer is handled one time.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a frame display method according to one embodiment of the present application.

FIG. 2 is a schematic diagram illustrating a frame display method according to another embodiment of the present application.

FIG. 3 is a block diagram illustrating a frame display device according to one embodiment of the present application.

FIG. 4 is a flow chart illustrating a frame display method according to one embodiment of the present application.

### DETAILED DESCRIPTION

In the following descriptions, several embodiments are provided to explain the concept of the present application. The terms “first”, “second”, “third” in following descriptions are only for the purpose of distinguishing different one elements, and do not mean the sequence of the elements. For example, a first device and a second device only mean these devices can have the same structure but are different devices.

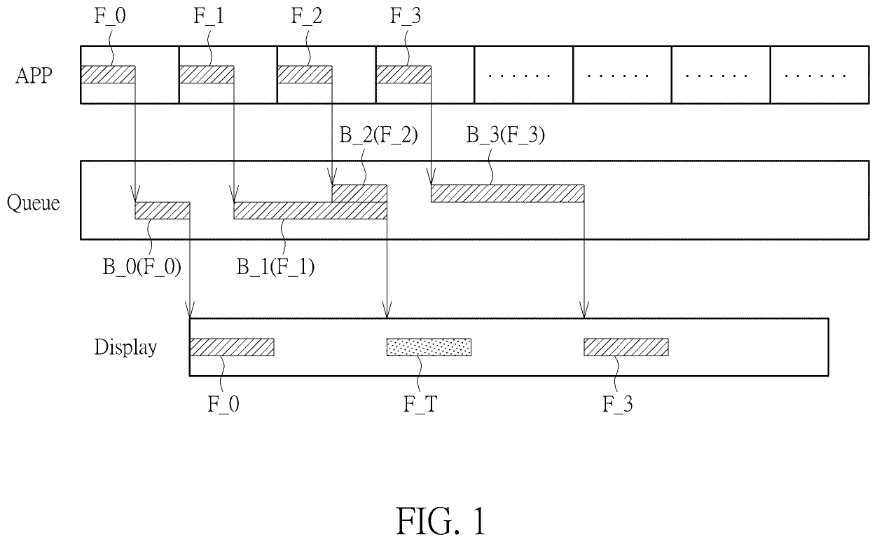

FIG. 1 is a schematic diagram illustrating a frame display method according to one embodiment of the present application. The frame display method is applied to a frame display device installed with an application. In following embodiments, the buffers are provided in a queue, but are not limited. As shown in FIG. 1, generations of the frames F_0, F_1, F_2, F_3 are sequentially required by the application. Then, the frames F_0, F_1, F_2, F_3 are sequentially stored to the buffers B_0, B_1, B_2 and B_3. Please note, the lengths of the buffers B_0, B_1, B_2 and B_3 are only used for explaining the operations that the frame recorded in the buffer is retrieved and then displayed, rather than used for limiting the sizes of buffers or frames.

In the embodiment of FIG. 1, the frame F_0 is retrieved from the buffer B_0 and then displayed by the frame display device. After that, the frame F_1 in the buffer B_1 and the frame F_2 in the buffer B_2 are retrieved sequentially. However, the frame F_1 and the frame F_2 are not displayed. A target frame F_T is generated according to the frame F_1 and the frame F_2, and then the target frame F_T is displayed. By this way, more than one buffer can be processed one time, thus the buffer accumulation issue can be improved. In one embodiment, after the target frame F_T is generated, the frame F_1 and the frame F_2 are discarded from the buffer B_1 and the buffer B_2, respectively.

Various frame generation methods can be used to generate the target frame F_T. In one embodiment, interpolation is performed according to the frame F_1 and the frame F_2 to generate the target frame F_T. In another embodiment, the frame F_1 and the frame F_2 are processed such that the frame F_1 and the frame F_2 are combined with an appearance of partial transparency. In such case, the frame F_1 and the frame F_2 may be processed by, for example, Alpha blending to generate the target frame F_T. However, the scope of the present application is not limited Alpha blending. Any other algorithm which has similar functions can also be applied to the present application.

In one embodiment, one of the frame generation methods is selected (e.g., one of the interpolation and the Alpha blending is selected) according to at least one of following conditions: a power condition of the frame display device, a quality requirement of the target frame F_T, a loading state of a frame generation device of the frame display device, and required visual effects of the target frame F_T.

The power condition of the frame display device may represent any information of a power of the frame display device. For example, the power condition may represent a battery level of a battery of the frame display device, or power distribution conditions of all devices in the frame display device. If more available power can be used to generate the target frame F_T, the frame generation method with a higher processing ability may be selected. On the contrary, if less available power can be used to generate the target frame F_T, the frame generation method with a lower processing ability may be selected.

The quality requirement of the target frame F_T may be manually set by the user of the frame display device or be automatically set by the application installed to the frame display device. The quality may be a resolution or a contrast of the target frame F_T, but not limited. If a higher quality of the target frame F_T is required, the frame generation method with a higher processing ability may be selected. On the contrary, if a lower quality of the target frame F_T is required, the frame generation method with a lower processing ability may be selected.

The loading state of a frame generation device of the frame display device may mean whether the frame generation device has many tasks to be processed or not. If the loading state is high, the frame generation method which has a lower processing ability may be selected. On the opposite, if the loading state is low, the frame generation method which has a higher processing ability may be selected. The frame generation device may be a CPU (Central Processing Unit) or a GPU (Graphics Processing Unit). However, the frame generation device can be any other device which has the frame generation ability. For example, the frame generation device can be an image processing hardware engine, which may perform alpha blending, overlay composition or other image processing tasks.

Required visual effects of the target frame F_T may mean, for example, the required image effects (e.g., light and shadow effects or game effects) of the target frame F_T. If the target frame F_T needs more visual effects, the frame generation method which has a higher processing ability may be selected. On the opposite, if the target frame F_T needs fewer visual effects, the frame generation method which has a lower processing ability may be selected.

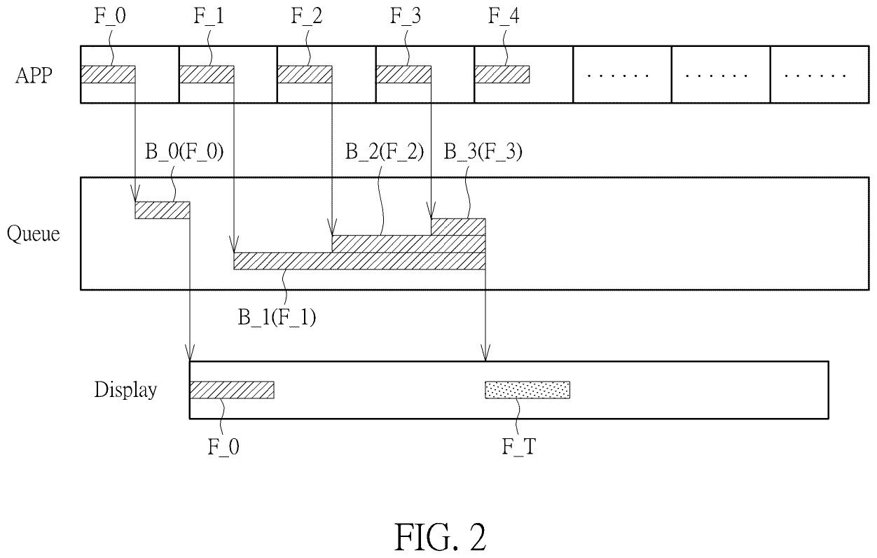

In one embodiment, besides the frame F_1 and F_2, the target frame F_T can further be generated according to contents of at least one frame besides the frame F_1 and the frame F_2. FIG. 2 is a schematic diagram illustrating a frame display method according to another embodiment of the present application. As shown in FIG. 2, generations of the frames F_0, F_1, F_2, F_3 are sequentially required by the application. Then, the frames F_0, F_1, F_2, F_3 are sequentially stored to the buffers B_0, B_1, B_2 and B_3. The frame F_0 is retrieved from the buffer B_0 and then displayed by the frame display device. After that, the frame F_1 in the buffer B_1, the frame F_2 in the buffer B_2 and the frame F_3 in the buffer B_3 are retrieved sequentially. However, the frame F_1, the frame F_2 and the frame F_3 are not displayed. A target frame F_T is generated according to the frame F_1, the frame F_2 and the frame F_3, and then the target frame F_T is displayed. The frame generation method of the target frame F_T in the embodiment of FIG. 1 can also be applied to the embodiment of FIG. 2. Accordingly, detail descriptions of the frame generation method are omitted for brevity here. In one embodiment, after the target frame F_T is generated, the frame F_1, the frame F_2 and the frame F_3 are discarded from the buffer B_1, the buffer B_2 and the buffer B_3, respectively.

Comparing with the embodiment in FIG. 1, FIG. 2 generates the target frame F_T according to frames in three buffers rather than two buffers. Such rule can be applied to any other number of buffers rather than limited to two or three. Accordingly, the frame display methods disclosed in the embodiments can generate the target frame F_T according to frames in two buffers or in more than two buffers.

In one embodiment, the frame display device may selectively operate in one of two modes: a first mode and a second mode. In the first mode, the operations stated in FIG. 1 and FIG. 2 are performed. On the contrary, in the second mode, the target frame is not generated and the frames in buffers are displayed in sequence. In other words, the frame display method disclosed in the embodiments of the present application is performed when the frame display device operates in the first mode and not performed when the frame display device operates in the second mode.

In one embodiment, the frame display device operates in one of the first mode and the second mode according to at least one of following conditions: a number of the buffers which have frames stored therein, a frame generation frequency required by the application, a touch frequency that an object touches the frame display device, and a type of the application.

The buffers which have frames stored therein mean a level of the buffer accumulation. Accordingly, if the buffers which have frames stored therein are more than a number threshold, the frame display device may operate in the first mode to improve the buffer accumulation. Oppositely, if the buffers which have frames stored therein are less than the number threshold, the frame display device may operate in the second mode.

The frame generation frequency required by the application is relative to the buffer accumulation. If more frames are required by the application to be generated in a time interval, the frame generation frequency is high. Oppositely, if fewer frames are required by the application to be generated in the time interval, the frame generation frequency is low. If the required frame generation frequency is higher than a frequency threshold, the frame display device may operate in the first mode to improve the buffer accumulation. Oppositely, if the required frame generation frequency is lower than the frequency threshold, the frame display device may operate in the second mode.

A touch frequency that an object touches the frame display device may represent a frame generation frequency required by the application. For example, if a user is playing a game via a mobile phone and use a finger to quickly and continuously tap the touch screen of the mobile phone to control the game, the frame generation frequency required by the application is high. In such case, the frame display device may operate in the first mode to improve the buffer accumulation. On the contrary, if the user taps the screen less frequently or slowly, the frame generation frequency required by the application is low, thus the frame display device operates in the second mode.

The type of the application which requires frame generation may represent the number of required frames or the required frame generation frequency, which may affect the level of buffer accumulation. Accordingly, if the application type means that the application may require a large number of frames or a high frame generation frequency (e.g., an action game), the frame display device may operate in the first mode to improve the buffer accumulation. On the opposite, if the application type means that the application may require fewer frames or a low frame generation frequency (e.g., a document reader application), the frame display device may operate in the second mode.

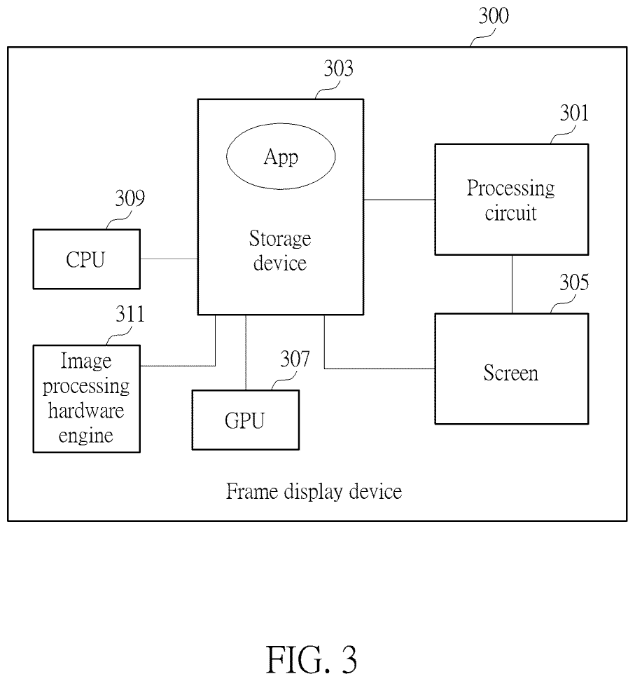

As above-mentioned, the frame display methods can be performed by a frame display device, which can have various structures. FIG. 3 is a block diagram illustrating a frame display device 300 according to one embodiment of the present application. Please note, the above-mentioned embodiments can be implemented by other devices rather than limited to the frame display device 300. The frame display device 300 can be any device which can display frames, such as a mobile phone or a tablet computer. As shown in FIG. 3, the frame display device 300 comprises a processing circuit 301, a storage device 303 and a screen 305. The above-mentioned buffers can be provided inside the screen 305 or outside the screen 305. Also, as above-mentioned, the buffers may be provided in queue, which is not illustrated in FIG. 3.

The above-mentioned application is installed to the storage device 303. The application can also be installed to a storage device which is different from the storage device 303. Also, the storage device 303 may store at least one program, and the processing circuit 301 executes the program to perform the above-mentioned embodiments. For example, the processing circuit 301 controls the frame retrieving stated in FIG. 1, and controls or performs the generation of the target frame F_T. The generation of the target frame F_T may be performed by any other device, such as the frame generation device in the frame display device 300.

The screen 305 is configured to display the frames, as shown in FIG. 1 and FIG. 2. The screen 305 may be a touch screen, thus a user can perform touch control to the frame display device 300 via the screen 305. Additionally, as above-mentioned, the frame display device 300 may comprise at least one frame generation device which is used to generate frames according to the requirement from the application, such as the GPU 307, the CPU 309 or the image processing hardware engine 311. In one embodiment, the processing circuit 301 is integrated to the CPU 309.

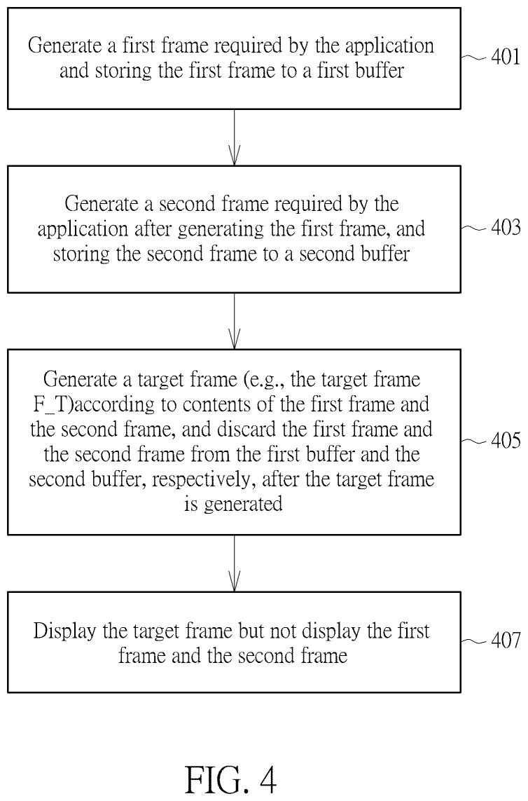

In view of above-mentioned embodiments, a frame display method can be acquired, which applied to a frame display device (e.g., the frame display device 300) installed with an application and comprising a plurality of buffers. FIG. 4 is a flow chart illustrating a frame display method according to one embodiment of the present application, which comprises following steps:

### Step 401

Generate a first frame (e.g., the frame F_1) required by the application and storing the first frame to a first buffer (e.g., B_1).

### Step 403

Generate a second frame (e.g., the frame F_2) required by the application after generating the first frame, and storing the second frame to a second buffer (e.g., B_2).

### Step 405

Generate a target frame (e.g., the target frame F_T) according to contents of the first frame and the second frame, and discard the first frame and the second frame from the first buffer and the second buffer, respectively, after the target frame is generated.

### Step 407

Display the target frame but not display the first frame and the second frame.

In one embodiment, the step 405 and the step 407 are performed when the frame display device operates in a first mode. In such case, the frame display method further comprises: not generating the target frame and sequentially displaying the first frame and the second frame when the frame display device operates in a second mode. As above-mentioned, the frame display device operates in one of the first mode and the second mode according to at least one of following conditions: a number of the buffers which have frames stored therein, a type of the application, a frequency that an object touches the frame display device, and a frame rate of frames required by the application.

In view of above-mentioned embodiments, the buffer accumulation issue can be improved, since more than one buffer is handled one time.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A frame display method, applied to a frame display device
installed with an application and comprising a plurality of buffers, comprising:
(a) generating a first frame required by the application and storing the first frame to a first buffer;
(b) generating a second frame required by the application after generating the first frame, and storing the second frame to a second buffer;
(c) generating a target frame according to contents of the first frame and the second frame and discarding the first frame and the second frame from the first buffer and the second buffer, respectively, after the target frame is generated; and
(d) displaying the target frame but not displaying the first frame and the second frame.

2. The frame display method of claim 1, wherein the step (c) performs interpolation according to the first frame and the second frame to generate the target frame.

3. The frame display method of claim 1, wherein the step (c) combines the first frame and the second frame with an appearance of partial transparency.

4. The frame display method of claim 3, wherein the step (c) uses Alpha blending to combine the first frame and the second frame to generate the target frame.

5. The frame display method of claim 1, wherein the step (c) generates the target frame according to the first frame and the second frame and further according to contents of at least one frame stored in the buffer besides the first frame and the second frame.

6. The frame display method of claim 1, wherein the buffers are in a queue of the frame display device.

7. The frame display method of claim 1, wherein the step (c) and
the step (d) are performed when the frame display device operates in a first mode, wherein the frame display method further comprises:
not generating the target frame and sequentially displaying the first frame and the second frame when the frame display device operates in a second mode;
wherein the frame display device operates in one of the first mode and the second mode according to at least one of following conditions:
a number of the buffers which have frames stored therein, a frame generation frequency required by the application, a type of the application, and a touch frequency that an object touches the frame display device.

8. The frame display method of claim 1, wherein the steps (c)
selects one of a plurality of frame generation methods to generate the target frame according to at least one of following conditions:
a power condition of the frame display device, a quality requirement of the target frame, a loading state of a frame generation device of the frame display device, and required visual effects of the target frame.

9. The frame display method of claim 8, wherein the frame generation device is a CPU (Central Processing Unit) or a GPU(Graphics Processing Unit), or an image processing hardware engine.

10. A frame display device, installed with an application, comprising:
a storage device, storing at least one program;
a plurality of buffers, comprising a first buffer and a second buffer; and
a processing circuit, configured to execute at least one program to perform a frame display method comprising:
(a) generating a first frame required by the application and storing the first frame to a first buffer;
(b) generating a second frame required by the application after generating the first frame, and storing the second frame to a second buffer;
(c) generating a target frame according to contents of the first frame and the second frame, and discarding the first frame and the second frame from the first buffer and the second buffer, respectively, after the target frame is generated; and
(d) displaying the target frame but not displaying the first frame and the second frame.

11. The frame display device of claim 10, wherein the step (c) performs interpolation according to the first frame and the second frame to generate the target frame.

12. The frame display device of claim 10, wherein the step (c) combines the first frame and the second frame with an appearance of partial transparency.

13. The frame display device of claim 12, wherein the step (c) uses Alpha blending to combine the first frame and the second frame to generate the target frame.

14. The frame display device of claim 10, wherein the step (c) generates the target frame according to the first frame and the second frame and further according to contents of at least one frame stored in the buffer besides the first frame and the second frame.

15. The frame display device of claim 10, wherein the buffers are in a queue of the frame display device.

16. The frame display device of claim 10, wherein the step (c) and the step (d) are performed when the frame display device operates in a first mode, wherein the frame display device further comprises:
not generating the target frame and sequentially displaying the first frame and the second frame when the frame display device operates in a second mode;
wherein the frame display device operates in one of the first mode and the second mode according to at least one of following conditions:
a number of the buffers which have frames stored therein, a frame generation frequency required by the application, a type of the application, and a touch frequency that an object touches the frame display device.

17. The frame display device of claim 10, wherein the steps (c) selects one of a plurality of frame generation methods to generate the target frame according to at least one of following conditions:
a power condition of the frame display device, a quality requirement of the target frame, a loading state of a frame generation device of the frame display device, and required visual effects of the target frame.

18. The frame display device of claim 17, wherein the frame generation device is a CPU (Central Processing Unit), a GPU(Graphics Processing Unit), or an image processing hardware engine.
